(19) United States
(12) Patent Application Publication
(10) Pub. No.: US 2011/0174298 A1
(43) Pub. Date: Jul. 21, 2011

(54) METHODS AND SYSTEMS FOR HIGH-PERFORMANCE SOLAR RADIATION COLLECTION

(76) Inventor: Steven J. Aldrich, Chesapeake, VA (US)

(21) Appl. No.: 12/980,698

(22) Filed: Dec. 29, 2010

Related U.S. Application Data
(60) Provisional application No. 61/297,163, filed on Jan. 21, 2010.

(51) Int. Cl. F24J 2/48; B23P 15/26

(52) U.S. Cl. 126/677; 29/890.033

(57) ABSTRACT

An apparatus is provided for converting solar radiation into thermal energy via a first and second non-ferrous metal conduit joined in a serpentine configuration by a non-ferrous metal end fitting. In one aspect, the apparatus is a high performance solar radiation collector converting solar radiation into thermal energy and transferring said thermal energy to a liquid transfer medium flowing through the collector.

### CROSS-REFERENCE TO RELATED APPLICATIONS

This application claims priority from U.S. Provisional Patent Application Ser. No. 61/297,163, filed on Jan. 21, 2010, entitled “High Performance Flat Panel Copper Solar Collector”, which is hereby incorporated by reference.

### BACKGROUND

1. Field

This disclosure relates to equipment for solar radiation collection.

2. Description of Related Art

Solar radiation collectors try to capture the solar radiation energy that strikes the earth to greatest extent possible. The amount of solar radiation striking any surface area of the earth is a fixed amount per day (without clouds) for any given location and time of year. Conventional flat-panel collectors enlist the use of a metal surface (usually in sheet fashion) with tubes attached to absorb and transfer the thermal energy to a liquid within the tubes, which is then transported elsewhere for use. Conventional parabolic collectors enlist the use of mirrored parabolic surfaces to concentrate the solar radiation onto a metal surface that will absorb and transfer the thermal energy to a liquid or gas within the structure, which is then transported elsewhere for use. Conventional evacuated tube collectors enlist the use of a glass tube that is evacuated of air to eliminate heat loss through convection and radiation. Contained within the tubes, are either a looped tube that contain liquid that is heated or a metal plate that is attached to a hollow tube that contains a liquid that vaporizes and rises to a metal heat exchanger lying within yet another tube that contains a liquid or gas within the tube which is then transported elsewhere for use. Conventional solar radiation collectors typically require that the solar radiation striking the collector in whatever fashion should ultimately pass through a conduit wall or heat exchanger to transfer the heat by means of conduction to a liquid as might be used. Conventional solar collectors are typically limited to a maximum of sixty to seventy percent efficiency.

The flow of thermal energy as required by the second law of thermodynamics goes from a high thermal energy to a lower thermal energy. The law of Heat Conduction or “Fourier's Law”, states that the time rate of heat transfer through a “material” is proportional to the negative gradient in the temperature and to the area at right angles, to that gradient, through which the heat is flowing. In a one-dimensional differential form, Fourier's Law is as follows: q=Q/A=−kdT/dx. The heat transfer or conduction rate of a material is given by: q=−kA (ΔT/L), where, k is the thermal conductivity of the material, L is the length of heat travel through the material (the wall of the conduit), A is the cross-sectional area of material orthogonal to the travel of heat and ΔT is the temperature difference between the two sides, with the final units being Watts per Meter² or Joules per second making the whole process a time/rate of change situation.

When the intent is to heat a liquid within a conduit to the largest absolute temperature difference between when the liquid enters the system and when the liquid exits, the liquid should have an increased time interval within the system. Increasing the time interval a liquid within the conduit experiences can be accomplished by two means for a given size system (length×width×height): decrease the flow rate of the liquid and/or increase the travel path length as in a serpentine fashion. Many flat panel collectors utilize headers that consolidate the flow from many tubes running across the surface of the collector. FIG. 1 depicts the maximum flow path length of the transfer liquid within a typical prior art arrangement. At the interior face of the conduit the liquid transfers heat by means of convection to adjacent liquid within the conduit when not all the liquid experiences contact with the conduit wall.

### BRIEF SUMMARY

In one aspect, the methods and systems described herein provide a solar radiation collector that improves upon past art and may be incorporated into currently available collector housings.

In another aspect, an apparatus is provided for converting solar radiation into thermal energy via a first and second non-ferrous metal conduit joined in a serpentine configuration by a non-ferrous metal end fitting. In one embodiment, the apparatus is a high performance solar radiation collector converting solar radiation into thermal energy and transferring said thermal energy to a liquid transfer medium flowing through the collector.

In still another aspect, a solar radiation collector employs a plurality of flattened non-ferrous metal conduits that are adjacent to one another. In one embodiment, each of the plurality of flattened non-ferrous metal conduits is located immediately adjacent to another. A plurality of cast molded non-ferrous metal conduit fittings provide for the joining of adjacent flattened non-ferrous metal conduits to cause a reversal in direction of fluid flow to the next adjacent non-ferrous conduit thus creating a serpentine geometry of conduits within the collector housing. Tubes of the same non-ferrous material on the underside and perpendicular hold this collection of conduits and fittings together the lengths of the conduits. In some embodiments, the parts are spray-painted flat black. In other embodiments, a selective chrome-black finish is deposited on the surface of the parts by, for example, electroplating.

In one embodiment, the conduits are made from non-ferrous metal pipes that are flattened. In another embodiment, non-ferrous metal can be extruded into a flattened geometry that forms the conduits. One of ordinary skill in the art should understand the practices that may be used to flatten the pipes or to manufacture by extrusion the flattened conduits.

In some embodiments, the inclusion of the non-ferrous metal end fittings result in improved conduits. In other embodiments, allowing for non-ferrous metal end fittings composed of materials other than copper (such as, and without limitation, aluminum or any non-ferrous material) result in improved conduit.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 depicts one embodiment of a prior art tubes entering headers and the maximum fluid path available for thermal heating of the transfer liquid;

FIG. 2 is a top view of one embodiment of a high performance solar radiation collector;

FIG. 3 is a cross-sectional view of the flattened non-ferrous metal conduits and the underlying non-ferrous support tube taken on line 2-2 of FIG. 2;

FIG. 4 is a top view of a flattened non-ferrous metal conduit;

FIG. 5 is a cross-sectional view of one embodiment of a flattened non-ferrous metal conduit on line 5-5 of FIG. 4;

FIG. 6 is an isometric end view of one embodiment of a flattened metal conduit of FIG. 4 incorporated in a solar radiation collector;

FIG. 7 is a top view of one embodiment of a non-ferrous metal end fitting, wherein the dashed lines representing the limits of the interior cavity of said fitting and the hatching represents solid material;

FIG. 8 is a cross-sectional view of one embodiment of a non-ferrous metal end fitting taken along line 8-8 of FIG. 7;

FIG. 9 is an isometric view of one embodiment of a non-ferrous end fitting of FIG. 7;

FIG. 10 is a black and white photograph of an embodiment of three non-ferrous metal end fittings coupled with two sections of flattened non-ferrous metal conduits; and

FIG. 11 is a black and white photograph of one embodiment of a section of flattened non-ferrous metal conduit.

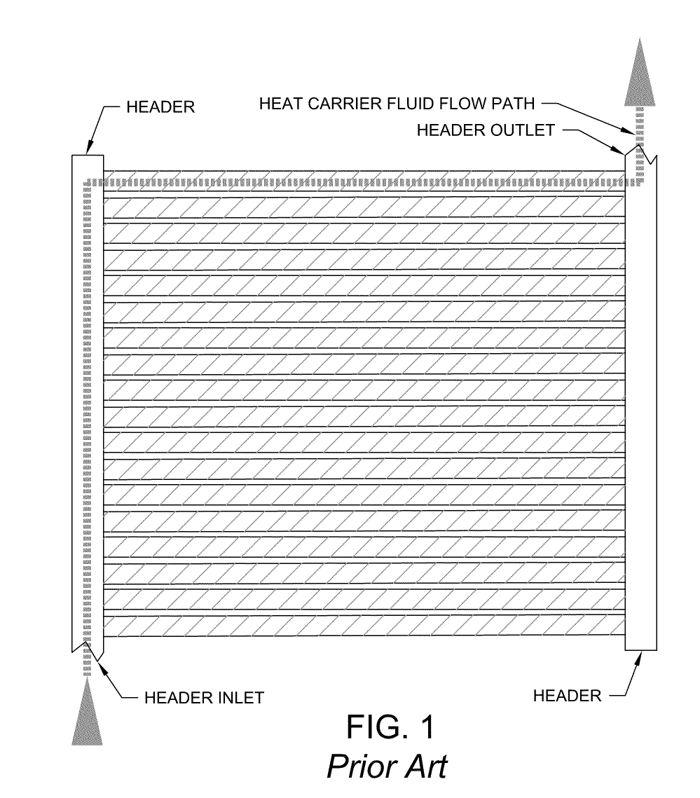

### DETAILED DESCRIPTION

A solar radiation collection apparatus utilizes a cast molded non-ferrous metal end fitting to provide for the joining of adjacent flattened non-ferrous metal conduits to facilitate a reversal in direction of fluid flow. The conduit fitting provides for a small offset from the previous and next adjacent conduits thereby maximizing the surface area of the non-ferrous metal flattened conduits exposed to solar radiation within any given enclosure. The serpentine fashion and the thinness of the collector conduits allows for a high absolute temperature difference between when the liquid enters the collector and when the liquid exits the collector thereby making increased heat available for immediate use or stored for use later. In some embodiments, use of a solar radiation collector as described herein may result in a higher efficiency than that provided by conventional collectors.

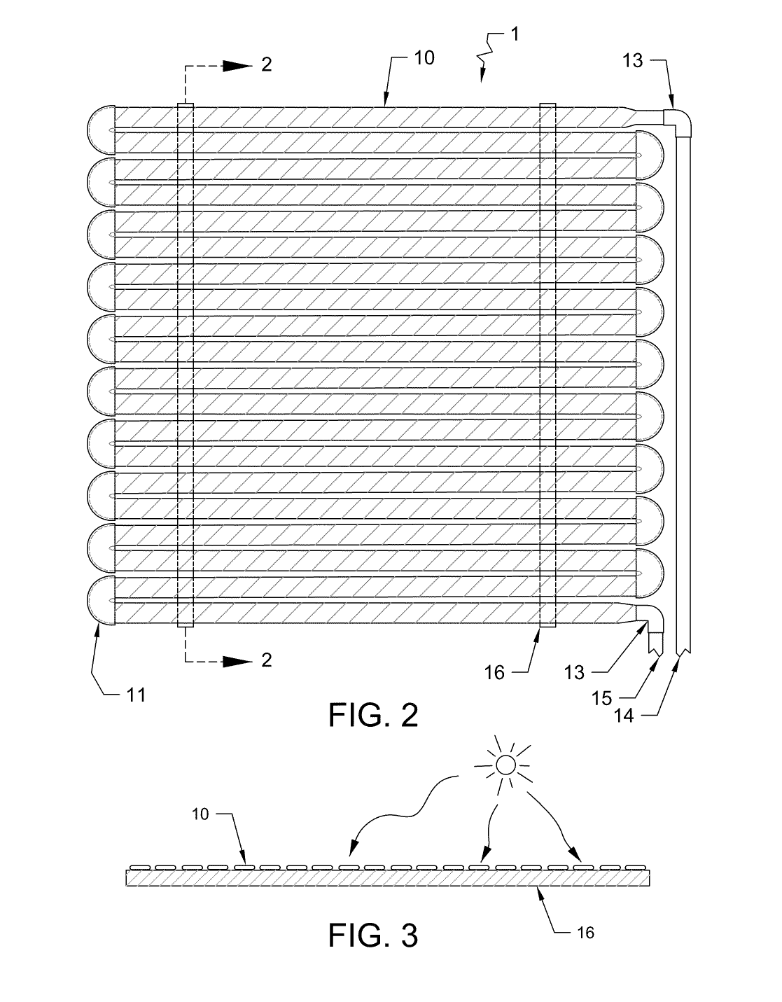

Referring now to FIG. 2, and in brief overview, a diagram depicts one embodiment of a high performance solar radiation collection apparatus 1 for collecting solar radiation as thermal energy, which is transferred to a liquid heat transfer medium. The apparatus 1 in FIG. 2 includes a plurality of flattened non-ferrous metal conduits 10; each flattened non-ferrous metal conduit 10 at each end is connected to adjacent flattened non-ferrous metal conduits by means of a non-ferrous metal end fitting 11 by means of brazing or welding, with the exception of the first and last flattened non-ferrous metal conduits 12 which are round on one end to facilitate coupling to standard plumbing ells 13 by means of brazing or soldering. Standard plumbing pipe 14 and 15 in FIG. 2 serve as entry and exit for the liquid heat transfer medium. In one embodiment, a flattened non-ferrous metal conduit has an interior distance between opposite sides to be 2 to 7 times the wall thickness of the conduit. In another embodiment, the width of the flattened non-ferrous metal conduit is not limited to any specific value or ratio to thickness.

Referring now to FIG. 3, the collection of connected flattened non-ferrous metal conduits 10 and non-ferrous metal end fittings 11 are brazed onto round conduits 16 made of the same non-ferrous metal. The supporting conduits are made of the same material to prevent an electrolytic potential and possible corrosion of the flattened non-ferrous metal conduits 10. The entire apparatus 1 may be spray-painted flat black or electroplated with a selective chrome/black finish.

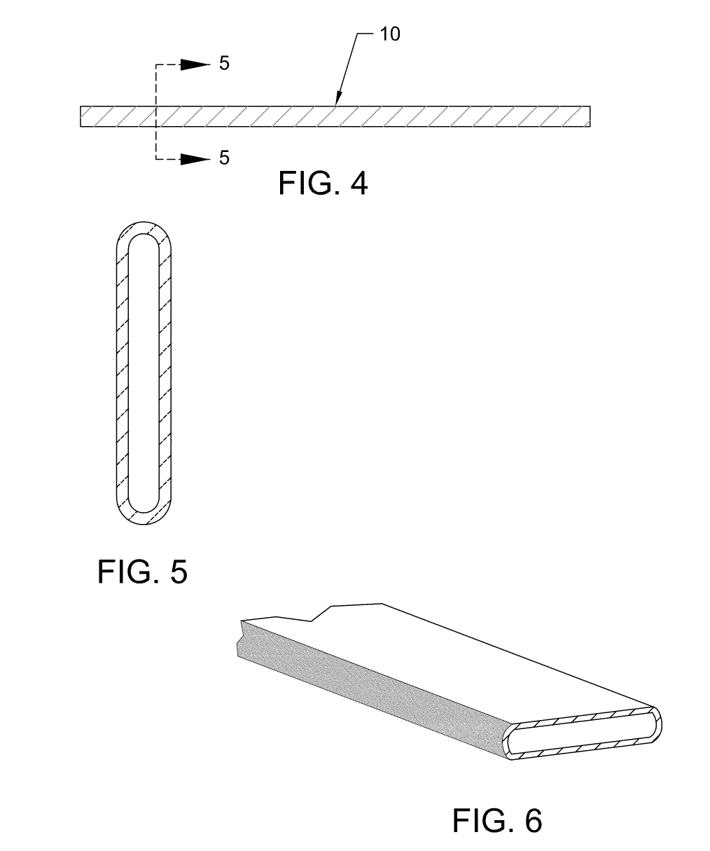

FIG. 4 depicts one embodiment of a flattened non-ferrous conduit. In some embodiments, the flattened non-ferrous conduit can be made from ordinary “Type M” copper pipe available at any plumbing supply vendor. In one embodiment, the copper pipe is annealed by subjecting the pipe to a uniform heat of 800 degrees Fahrenheit and then quenched in a water bath whose temperature is no greater that 70 degrees Fahrenheit. The annealed copper pipe is then flattened in a hydraulic or screw press and ready for use. In some embodiments, the flattened non-ferrous conduit can be made from aluminum. The aluminum can be extruded to the required flattened geometry. Extrusion of aluminum is performed by hydraulically forcing a heated billet of aluminum through a die conforming to the chosen geometry. Referring now to FIG. 5, and in greater detail, a diagram shows a cross-sectional view of the flattened non-ferrous conduit taken along line 5-5 in FIG. 4. FIG. 6 is a diagram depicting an isometric view of the flattened non-ferrous conduit.

The non-ferrous metal end fitting 11 can be made by any standard foundry methods such as, without limitation, die-casting, investment casting or sand casting.

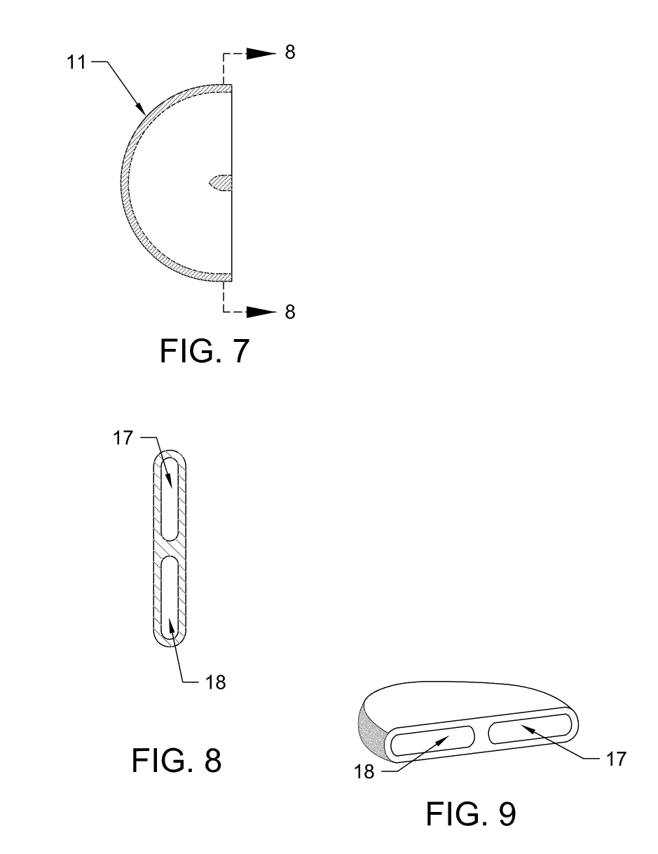

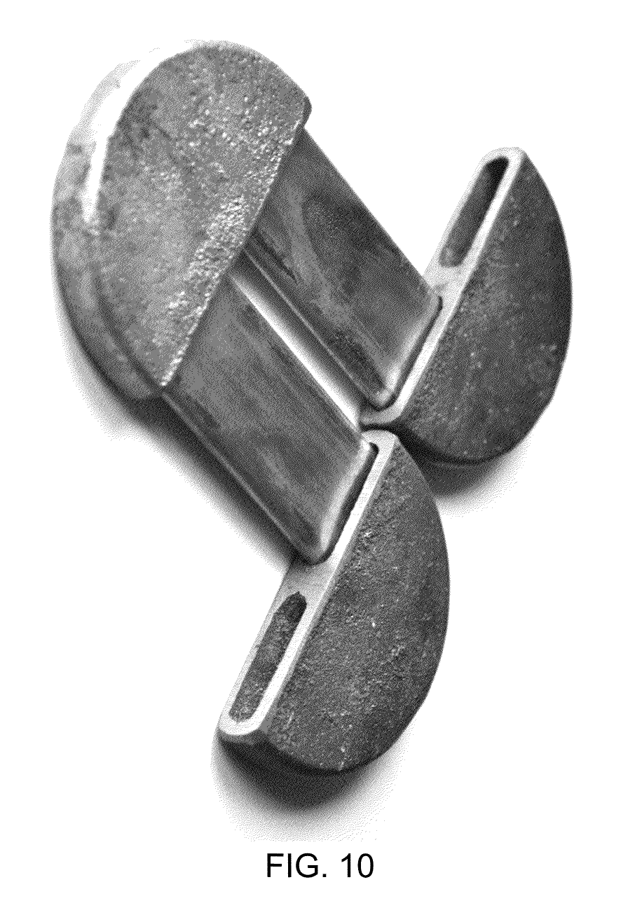

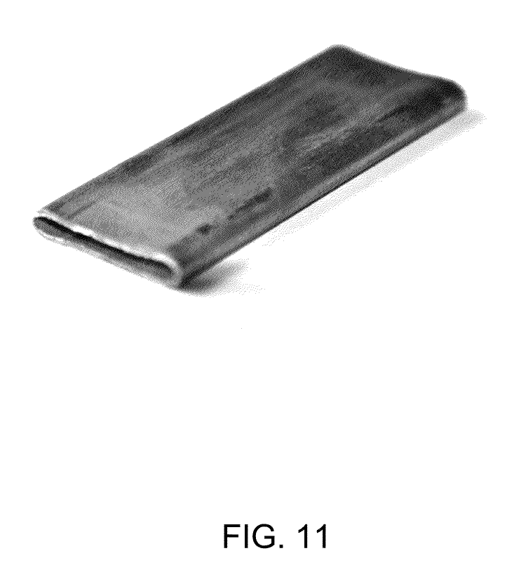

Referring now to FIG. 7, a top view is shown of one embodiment of a non-ferrous metal end fitting, where the dashed lines represent the limits of the interior cavity of said fitting and the hatching represents solid material. In one embodiment, the interior cavity is produced by the foundry method of choice—such as, without limitation, die-casting, investment casting or sand casting—and utilizing a core in the mold cavity. Molten non-ferrous metal, brass, or aluminum, is poured about the core contained within the hollow cavity of the mold. After the molten metal solidifies, the core is extracted, thereby creating the cavity in the molded piece. The cavity has openings 17 and 18 as illustrated in FIG. 8 and FIG. 9 where the flattened non-ferrous metal conduits are inserted and brazed or welded. FIG. 10 is a black and white photograph of the unique non-ferrous metal fittings 11 made of brass with flattened non-ferrous metal (e.g., copper) conduits 10 inserted into several of the openings but are not brazed together. FIG. 11 is a black and white photograph of a piece of flattened non-ferrous metal conduit produced by flattening a piece round annealed “Type M” copper pipe.

In one embodiment, the high performance solar radiation collection apparatus 1 in FIG. 2 is installed in existing commercially available collector enclosures where the non-ferrous metal round conduits 16 serve as the connection point to the enclosure by means of screws or clamps. In one embodiment, the orientation of the apparatus 1 within the enclosure with regards to the entry and exit pipes 14 and 15 does not affect the function of the apparatus 1. Apparatus 1 of FIG. 2 and any suitable collector housing can be integrated with any system utilizing heated liquid transfer medium, an example being home heating via radiant heat in floors.

In FIG. 2, the serpentine flow path provided by the unique non-ferrous metal end fittings 11 and the extended surface area provided by the flattened non-ferrous metal conduits 10 provide an arrangement for capturing solar radiation as thermal energy. The absolute temperature rise across the collector of the liquid transfer medium can be modulated by increasing or decreasing the flow rate through the apparatus 1 by thermal sensors mounted on the inlet and outlet conduits which would be connected to a temperature comparator driving a variable output circulator pump. In one embodiment, this arrangement optimizes the temperature of the liquid transfer medium to suit the intended purpose at hand. Many other configurations within different systems are possible. In some embodiments, by incorporating both an increased area through which the liquid transfer medium flows and an increased time of contact between the sunlight and the conduits in the collector, the apparatus described herein provides an improved heat radiation collection. In one of these embodiments, the flattened tubes configured in a serpentine fashion increase the contact time between the surface of the heated non-ferrous material and the liquid transfer medium.

One of ordinary skill in the art should understand that conventional techniques may be used for the manufacture of the non-ferrous metal flattened conduits. In one embodiment, by way of example, the non-ferrous metal flattened conduits can be made by flattening round conduits to a flat geometry or by extruding non-ferrous metal to the required flattened geometry. In some embodiments, non-ferrous metals that may be used are not limited to copper or aluminum.

What is claimed is:

1. An apparatus for converting solar radiation into thermal energy, the apparatus comprising:
a first non-ferrous metal conduit with a flattened geometry; and
a non-ferrous metal end fitting joining, in a serpentine configuration, the first non-ferrous metal conduit with a second non-ferrous metal conduit.

2. The apparatus of claim 1 in which the first non-ferrous metal conduit comprises an aluminum conduit.

3. The apparatus of claim 1 in which the first non-ferrous metal conduit comprises a copper conduit.

4. The apparatus of claim 1 in which the second non-ferrous metal conduit comprises an aluminum conduit.

5. The apparatus of claim 1 in which the second non-ferrous metal conduit comprises a copper conduit.

6. The apparatus of claim 1 in which the second non-ferrous metal conduit is adjacent to the first non-ferrous metal conduit.

7. The apparatus of claim 1 in which the non-ferrous metal end fitting comprises an aluminum end fitting.

8. The apparatus of claim 1 in which the non-ferrous metal end fitting comprises a brass end fitting.

9. A method of manufacturing a solar radiation collector, the method comprising:
manufacturing a first non-ferrous metal conduit;
manufacturing a second non-ferrous metal conduit;
manufacturing a non-ferrous metal end fitting; and
joining, in a serpentine configuration, the first non-ferrous metal conduit with the second non-ferrous metal conduit via the non-ferrous metal end fitting.

10. The method of claim 9 further comprising converting, by the joined first and second non-ferrous metal conduits, solar radiation into thermal energy.

11. The method of claim 10 further comprising transferring said thermal energy to a liquid transfer medium flowing through the first and second non-ferrous metal conduits
